(19) United States
(12) Patent Application Publication
(10) Pub. No.: US 2025/0363861 A1
(43) Pub. Date: Nov. 27, 2025

(54) TICKET VOUCHERS EMPLOYED TO REFUND FINANCIAL INSTITUTION FEES BASED ON GAMING ESTABLISHMENT DEVICE ACTIVITY

(71) Applicant: IGT, Las Vegas, NV (US)

(72) Inventors: Dwayne R. Nelson, Las Vegas, NV (US); Kevin Higgins, Reno, NV (US); Yan Ha, Reno, NV (US)

(21) Appl. No.: 18/671,066

(22) Filed: May 22, 2024

(51) Int. Cl. G07F 17/32; G06Q 50/34

(52) U.S. Cl. CPC G07F 17/3255; G06Q 50/34; G07F 17/3239

(57) ABSTRACT

Systems and methods that enable a transfer of funds from an external account to a gaming establishment device, track a quantity of occurrences of an activity associated with the gaming establishment device, and if the tracked quantity of occurrences of the activity at least reaches a threshold quantity of occurrences, operate with a ticket voucher system to cause a ticket voucher associated with at least a determined refund amount of an assessed fee to be issued.

### BACKGROUND

In various embodiments, the systems and methods of the present disclosure enable a transfer of funds from an external account to a gaming establishment device, track a quantity of occurrences of an activity associated with the gaming establishment device, and if the tracked quantity of occurrences of the activity at least reaches a threshold quantity of occurrences, operate with a ticket voucher system to cause a ticket voucher associated with at least a determined refund amount of an assessed fee to be issued

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF DESCRIPTION OF THE SEVERAL VIEWS OF THE DRAWINGS

FIG. 1 is an example configuration of the architecture of a plurality of different components of the system of the present disclosure.

FIGS. 2A and 2B are flow charts of example processes for operating a system including various components that operate to, subject to any imposed fees, transfer funds from an external funding source that maintains an external account to a gaming establishment device.

FIGS. 3A and 3B are flow charts of example processes for operating a system including various components that operate to potentially refund any imposed fees associated with a transfer of funds from an external funding source that maintains an external account to a gaming establishment device.

FIGS. 4A and 4B are flow charts of example processes for operating a system including various components that operate to employ a ticket voucher in association with a refund of any imposed fees associated with a transfer of funds from an external funding source that maintains an external account to a gaming establishment device.

FIGS. 5A and 5B are flow charts of example processes for operating a system including various components that operate to employ a ticket voucher as part of the tracking of a transfer of funds from an external funding source that maintains an external account to potentially refund any imposed fees associated with the transfer.

### DETAILED DESCRIPTION

In various embodiments, the systems and methods of the present disclosure enable a transfer of funds from an external account to a gaming establishment device, track a quantity of occurrences of an activity associated with the gaming establishment device, and if the tracked quantity of occurrences of the activity at least reaches a threshold quantity of occurrences, operate with a ticket voucher system to cause a ticket voucher associated with at least a determined refund amount of an assessed fee to be issued

In certain embodiments, in association with the movement of funds from an external account to a gaming establishment device, the system of the present disclosure tracks certain activities occurring at the gaming establishment device and determines whether to trigger a refund of part or all of the fees incurred to move the funds from the external account to the gaming establishment device. In these embodiments, in view of certain external accounts being associated with a fee amount charged to complete a transfer of funds to a gaming establishment device and in view of certain users forgoing the transfer of funds to such gaming establishment devices because of these imposed fees, responsive to a determination that one or more activities occurring at (or in association with the gaming establishment device) warrant a refund eligibility, the system provides part or all of such imposed fees to the user. That is, based on zero, one or more events occurring (or not occurring) at a gaming establishment device which funds are transferred to from an external account (and/or based on zero, one or more events occurring (or not occurring) separate from such a gaming establishment device), the system determines whether or not to provide a user a partial or full refund of fees incurred from the transfer and if so, determines a form of the refund (e.g., cashable credits or non-cashable credits). Such a refund effectively minimizes (or eliminates) the impact of such fees and encourages the transfer of funds from one or more external accounts, such as one or more financial institution accounts, to one or more gaming establishment devices, such as an electronic gaming machine, a ticket voucher kiosk, or a gaming establishment retail system point-of-sale terminal. As such, to mitigate the ramifications of certain fees imposed in association with one or more transfers of funds to a gaming establishment device, the system causes certain users whom satisfy certain eligibility conditions to recoup part or all of such fees (to minimize the known psychological impact that these fees have on certain users) and thus realizes the technical benefits of a cashless gaming establishment environment.

In certain embodiments, the movement of funds from the external account to the gaming establishment device includes such funds moving to a gaming establishment account maintained by a gaming establishment fund management system followed by such funds moving to the gaming establishment device. In these embodiments, subject to the occurrence of certain refund triggering activities and, in certain instances, subject to any potential refund of any imposed fees complying with zero, one or more responsible gaming limits, the system credits the gaming establishment account for any refund of any part of the fees incurred to move the funds from the external account. For example, since the transfer of funds from a financial institution account (i.e., an external account) to an electronic gaming machine (i.e., a gaming establishment device) occurs indirectly with the funds first being transferred to a cashless wagering account (i.e., a gaming establishment account) before being transferred to the electronic gaming machine, subject to qualifying for a refund, a component that maintains the cashless wagering account (and/or a component of a refund system) causes part or all of the fees imposed in association with the transfer of funds from the financial institution account to be credited to the cashless wagering account.

In certain embodiments, the movement of funds from the external account to the gaming establishment device occurs via an electronic funds transfer that bypasses such funds moving to any gaming establishment accounts and rather occurs independent of any gaming establishment accounts and any wagering account transfers. In these embodiments, subject to the occurrence of certain refund triggering activities and, in certain instances, subject to any potential refund of any imposed fees complying with zero, one or more responsible gaming limits, the system credits the gaming establishment device for any refund of any part of the fees incurred to move the funds from the external account. For example, since the transfer of funds from a financial institution account (i.e., an external account) to an electronic gaming machine (i.e., a gaming establishment device) occurs directly and independent of any cashless wagering account (i.e., a gaming establishment account), subject to qualifying for a refund, a component of an electronic funds transfer system that coordinated the transfer of funds to the gaming establishment device (and/or a component of a refund system) causes part or all of the fees imposed in association with the transfer of funds from the financial institution account to be credited to a credit balance of the electronic gaming machine.

In certain embodiments, following the direct or indirect transfer of funds from the external account to the gaming establishment device and a determination, subject to the occurrence of certain refund triggering activities and, in certain instances, subject to any potential refund of any imposed fees complying with zero, one or more responsible gaming limits, that at least part of the fees imposed in association with the transfer of funds from the external account will be refunded back to the user, to deliver the refunded fees to the user, the system employs one or more ticket vouchers (e.g., an anonymous bearer instrument associated with an amount of funds and redeemable for cash via a kiosk, a cashier and/or game play on an electronic gaming machine). In certain of these embodiments, responsive to a ticket voucher generation event, the system increases an amount of a ticket voucher to account for the amount of fees to be refunded to the user. In certain other embodiments, responsive to a ticket voucher generation event, the system issues a second ticket voucher for the amount of fees to be refunded to the user. For example, following a user cashing out a credit balance from an electronic gaming machine, a component of a ticket voucher system operates with a component of a refund system (and/or a component of an electronic funds transfer system and/or a component that maintains a gaming establishment account associated with the user) to determine whether or not to issue a refund for fees incurred in association with the transfer of funds from a financial institution account to the electronic gaming machine. In this example, if the determination is to issue a refund of part or all of the fees incurred, the ticket voucher system causes one or more ticket vouchers, which include at least the refund amount, to be issued to the user.

Accordingly, following a transfer of funds from an external account which triggers an amount of fees, the system of certain embodiments of the present disclosure determines, based on an occurrence of a refund triggering activity event (i.e., one or more tracked activities reaching one or more thresholds) and subject to certain limits not being reached, whether to return part or all of such triggered fees back to the user. In such embodiments, if the system determines to return part or all of the triggered fees back to the user, the system employs a credit to a gaming establishment account maintained in association with the user, a credit to a balance of a gaming establishment device being operated by the user and/or an issued ticket voucher to provide such a refund to the user. Such a configuration encourages the employment of transfers of funds from external accounts which correspondingly decreases the employment of cash within a gaming establishment and thus realizes various technical benefits with reducing cash within the gaming establishment (e.g., less computation resources and less energy resources needed to be spent counting such cash, and less computational resources and less energy resources needed to maintain a certain amount of cash as available at a gaming establishment).

In certain embodiments, rather than directly or indirectly transferring funds from an external account to a gaming establishment device and then tracking activities at that gaming establishment device to determine whether or not a full or partial refund of any fees imposed on the transfer are warranted, the system employs a ticket voucher to initiate the tracking of activities occurring at one or more gaming establishment devices. In these embodiments, in association with a user withdrawing funds from an external account at a ticket voucher kiosk (or an automated teller machine (“ATM”)), the ticket voucher kiosk (or the ATM) operates with a component of a ticket voucher system to create and issue a ticket voucher. The ticket voucher is associated with the funds transferred from the external account and one or more identifiers indicative of such an external account transfer (e.g., an identifier associated with an amount of fees imposed on the transfer) such that when the user redeems the ticket voucher at a gaming establishment device, the system is aware that the funds deposited onto the gaming establishment device via the ticket voucher originated from an external account transfer with an amount of imposed fees. In these embodiments, aware that the funds associated with the redeemed ticket voucher incurred an amount of fees to be transferred from the external account, the system tracks the activities occurring at the gaming establishment device in association with a determination of whether or not to refund such fees. That is, the system associates a ticket voucher with occurrences of any external fees imposed and utilizes a redemption of that ticket voucher (and zero, one or more downstream or subsequently issued ticket vouchers that continue to track funds associated with imposed fees) to identify instances in which at least part of the fees imposed warrant being refunded back to the user.

Accordingly, certain embodiments of the present disclosure enable a transfer of funds from an external account (e.g., a financial institution account) directly or indirectly (via a gaming establishment account and/or a ticket voucher) to a balance of a gaming establishment device (e.g., an electronic gaming machine) in which certain tracked activities contribute to a reduction or elimination of the impact of one or more fees imposed in association with the transfer of funds from the external account. Since certain gaming establishment patrons are uncomfortable venturing into a gaming establishment with large amounts of cash, the system enables a user access to an amount of funds transferred from an external account without the need to handle cash. Such reduction in the use of cash at a gaming establishment provides a relatively more secure environment for a user (via reducing or eliminating a user carrying cash on their person and thus diminishing the risks that such cash may be lost or stolen), overcomes various health concerns associated with cash-based transactions (e.g., protecting patrons from using forms of currency that act as transmission vehicles for contagions), and benefits the gaming establishment by reducing the use of certain kiosks that accept cash (e.g., reducing the wear and tear on such devices and prolonging the operational life on these devices).

Additionally, by reducing the amount of cash transactions in a gaming establishment via enabling the transfer of funds from an external account to a gaming establishment device, the system reduces or eliminates human errors which often occur when cash is distributed at gaming establishment interfaces, such as casino desks. Specifically, eliminating gaming establishment personnel from distributing cash not only protects the user (if the gaming establishment personnel provides the gaming establishment patron a lower amount of cash than the patron deserves) but also protects the gaming establishment (if the gaming establishment personnel inadvertently or fraudulently provides the patron a higher amount of cash than the patron deserves). As such, the system of the present disclosure provides an alternative, non-cash-based option for a gaming establishment patron to transfer funds from an external account to a gaming establishment device while complying with various responsible gambling limitations which require the tracking of certain financial transactions associated with a gaming establishment patron and with the added benefit of potentially recouping part or all of any fees associated with the transfer of funds from the external account.

In various embodiments, the present disclosure is directed to a system including or otherwise in communication with various components and/or sub-systems that operate together to cause a transfer of an amount of funds from an external account, such as a financial institution account, to a gaming establishment device, such as an electronic gaming machine and track one or more activities to determine whether or not a refund of any part of the fees imposed for such a transfer of funds occurs. In these embodiments, one or more of the components that are part of the system (or otherwise operate with one or more components of the system) individually or collectively facilitate a transfer funds from an external account associated with a user to a gaming establishment device and further facilitate a determination of any fee refund to provide and a form of such a fee refund.

In certain embodiments, the present disclosure is directed to a gaming establishment fund management system including various sub-systems that are each associated with or otherwise maintain one or more electronic or virtual accounts. In these embodiments, the various accounts maintained for a user collectively form a resort or enterprise account (i.e., a gaming establishment fund management account) for the user. That is, the collection of cashless wagering accounts (e.g. cashless gaming establishment wagering wallets, cashless sports wagering wallets and/or cashless mobile wagering wallets) and gaming establishment retail accounts (e.g., gaming establishment retail wallets) associated with or otherwise maintained for a user individually and/or collectively form a resort or enterprise account (i.e., an integrated resort or gaming establishment fund management wallet) that the user may access to transfer funds and/or view balance information amongst the various accounts associated with or otherwise maintained for the user.

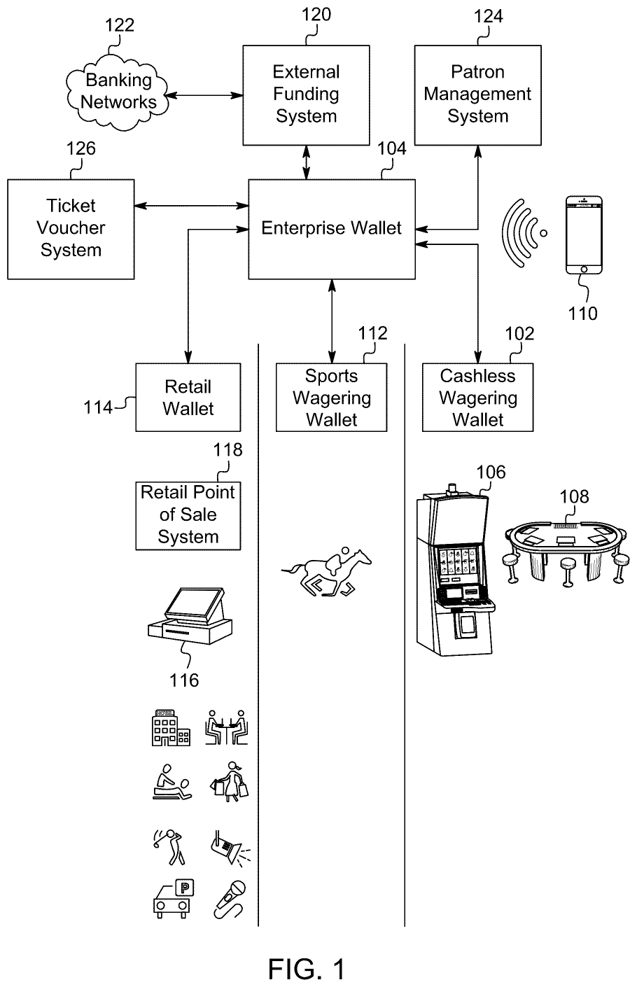

In various embodiments, the gaming establishment fund management system includes or is otherwise associated with one or more cashless wagering systems. Each cashless wagering system is associated with or otherwise maintain one or more cashless wagering accounts. In certain embodiments, the gaming establishment fund management system includes or is otherwise in communication with a first cashless wagering system that maintains a first cashless wagering account. In these embodiments, a user, such as a player of an electronic gaming machine (“EGM”), utilizes a mobile device application running on a mobile device and/or a physical instrument (e.g., a smart card or a user issued magnetic striped card which the user utilizes via inserting the card into a component of a gaming establishment patron management system associated with a gaming establishment device) to facilitate the electronic transfer of any funds between this first cashless wagering account and a gaming establishment device, such as a component of a gaming table and/or an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)). For example, as seen in FIG. 1, the gaming establishment fund management system includes a first cashless wagering system (not shown) that maintains a Cashless Wagering Wallet 102 (e.g., a first cashless wagering account) which is in communication with the enterprise wallet 104. In this example, to facilitate the transfer of funds between this cashless wagering account and a credit balance of an EGM 106 and/or a credit balance of a gaming table component (not shown) associated with a gaming table 108, the system utilizes a mobile device 110 running a mobile device application that interfaces with one or more components of the gaming establishment fund management system to enable a user, such as a player of the EGM or a player at the gaming table, access to this first cashless wagering account.

In certain embodiments, the gaming establishment fund management system additionally or alternatively includes or is otherwise in communication with a second cashless wagering system that maintains a second cashless wagering account. In these embodiments, funds associated with the second cashless wagering account are utilized to place one or more sporting event wagers and/or wagers placed remote from an EGM and a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this second cashless wagering account and a credit balance accessible to wager on sporting events and/or games of chance (or games of skill) remote from an EGM and a gaming table. For example, as seen in FIG. 1, the gaming establishment fund management system includes a second cashless wagering system (not shown) that maintains a Sports Wagering Wallet 112 (e.g., a second cashless wagering account) which is in communication with the enterprise wallet 104. In this example, to facilitate the transfer of funds between this cashless wagering account and a credit balance associated with a sporting event wagering system (not shown) and/or a remote wagering system (not shown) to enable the placement of one or more wagers on one or more sporting events and/or one or more games of chance (or games of skill), the system utilizes a mobile device 110 running a mobile device application that interfaces with one or more components of the gaming establishment fund management system to enable, amongst other activities, a user, such as a user remote from the gaming establishment, access to this second cashless wagering account.

In various embodiments, in addition to or an alternative of maintaining one or more cashless wagering accounts via one or more cashless wagering systems, the gaming establishment fund management system includes or is otherwise in communication with one or more gaming establishment retail wallet systems that each maintain one or more gaming establishment retail accounts. Such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, as seen in FIG. 1, the gaming establishment fund management system includes a gaming establishment retail wallet system (not shown) that maintains a Retail Wallet 114 (e.g., a gaming establishment retail account) which is in communication with the enterprise wallet 104. In this example, to facilitate the transfer of funds between this gaming establishment retail account and an account associated with a retailer to purchase goods and/or services from the retailer, the system utilizes a retail wallet identity, such as a mobile device 110 running a mobile device application that interfaces with a point-of-sale terminal 116 of a retail point-of-sale system 118 of the retailer and/or a physical instrument (e.g., a smart card or a user issued magnetic striped card which the user utilizes in association with the point-of-sale terminal), and one or more components of the gaming establishment fund management system to enable a user access to this gaming establishment retail account. In different embodiments, the gaming establishment retail account is operable to hold different types of instruments exchangeable for goods and/or services, such as, but not limited to, an amount of monetary funds, an amount of non-monetary funds (e.g., non-cashable promotional credits, promotional credits) and/or one or more coupons. In certain embodiments, the gaming establishment fund management system utilizes the gaming establishment retail wallet system as a transaction coordinator to account for any transactions to purchase goods and/or services from a retailer.

In certain embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In various embodiments, the system includes or is otherwise in communication with a payment gateway operable to interface with a banking network to communicate with one or more servers of one or more financial institutions that maintain one or more financial institution accounts and implement zero, one or more financial institution protocols, such as banking protocols. In such embodiments, the system includes a payment gateway operable with a banking network and one or more external funding sources (e.g., financial institutions) which maintain one or more external accounts (e.g., financial institution accounts) for a user to enable certain actions, including, but not limited to, balance inquiries, funding source enrollments and/or fund transfers.

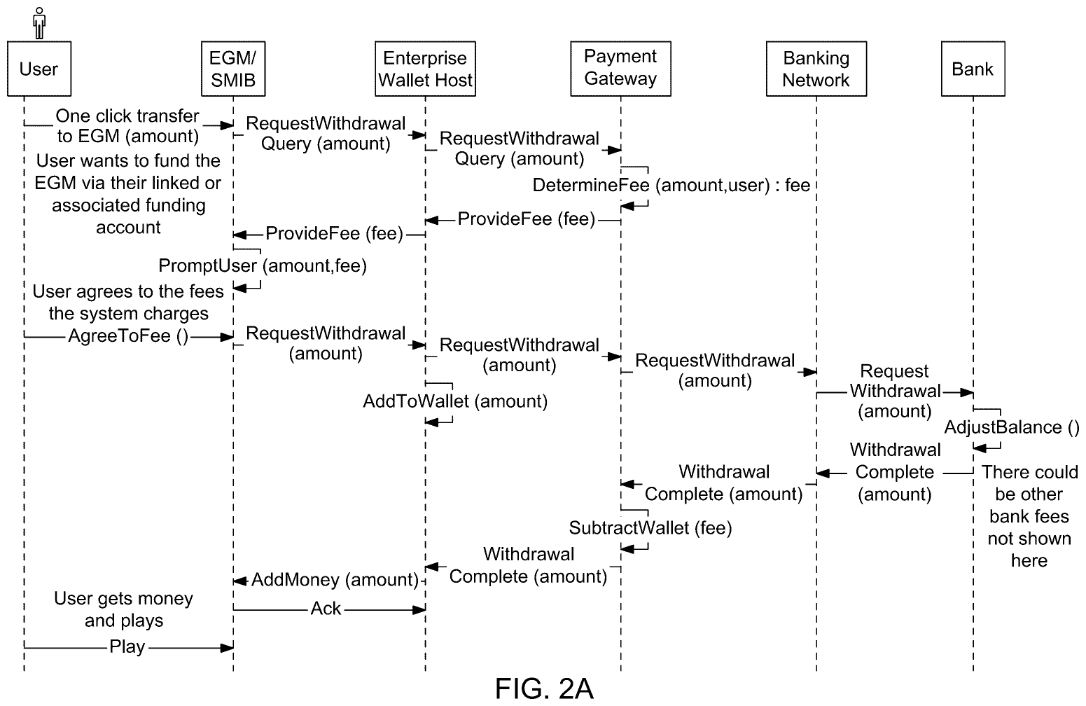

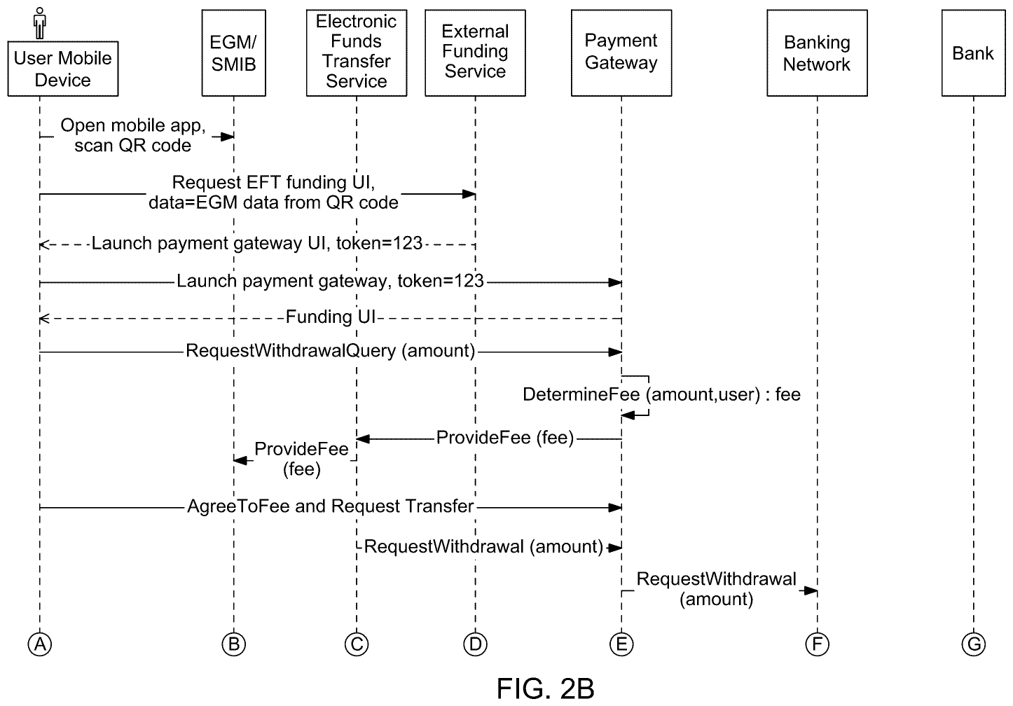

In certain embodiments, the system enables an amount of funds to be transferred from the external account to a gaming establishment account (e.g., a cashless wagering account) and then, as described above, from the gaming establishment account to a gaming establishment device, such as an EGM. In these embodiments, the system includes one or more servers operating as a payment gateway in communication with a network of one or more servers of one or more banks or other financial institutions (i.e., the banking networks) which operate to transfer funds from one or more accounts maintained at such banks or financial institutions to a gaming establishment account associated with a user (upon which part or all of such funds are then automatically or manually transferred from the gaming establishment account to a gaming establishment device). For example, as seen in FIG. 1, the gaming establishment fund management system that maintains the enterprise wallet 104 is in communication with a payment gateway (i.e., external funding system 120) which is in communication with a network of one or more banks or other financial institutions (i.e., the banking networks 122) which operate to electronically transfer funds between the user's accounts maintained at such banks or financial institutions and one or more of the accounts maintained by the gaming establishment fund management system. For example, as seen in FIG. 2A (which illustrates the described interactions between a user, an EGM and a slot machine interface board (i.e., a component of a gaming establishment patron management system) associated with the EGM, one or more components of a gaming establishment fund management system, a payment gateway, a banking network and a bank), certain embodiments of transferring funds from an external account maintained by an external funding source (i.e., a bank) to an EGM associated with a slot machine interface board (“SMIB”) include various gaming establishment components and non-gaming establishment components operating together to first transfer, subject to certain transfer fees, an amount of funds from an external account to a gaming establishment account maintained by a component of the gaming establishment fund management system (i.e., an enterprise wallet host) and then transferring part or all of the amount of funds from the gaming establishment account to a credit balance of the EGM.

In certain other embodiments, the system enables an amount of funds to be transferred from the external account to a gaming establishment device, such as an EGM, without first being transferred to any gaming establishment accounts associated with any users. In these embodiments, the system includes one or more servers operating as a payment gateway in communication with a network of one or more servers of one or more banks or other financial institutions (i.e., the banking networks) which operate to electronically transfer funds from one or more accounts maintained at such banks or financial institutions to a gaming establishment device via a series of one or more intermediaries operating directly or indirectly with the payment gateway and employing one or more protocols, such a slot accounting system (“SAS”) advanced funds transfer (“AFT”) debit transfer of a SAS protocol. In certain such embodiments, the system includes or is otherwise associated with an external funding service operable with the payment gateway. In these embodiments, one or more servers of the external funding service enable for a single entry point for all external funding transactions and if necessary, operate to disambiguate between destination sites of funds transferred from one or more external funding sources. In certain embodiments, the system includes or is otherwise associated with an electronic funds transfer service operable with the external funding service. In these embodiments, one or more servers of the electronic funds transfer service operate with one or more servers of the external funding service to direct funds transferred from an external funding source to the appropriate gaming establishment device. As such, in these embodiments, the system includes one or more servers operating as an electronic funds transfer service (i.e., an electronic funds transfer host) in communication with one or more servers operating as the external funding service (i.e., an external funding service host) to enable certain actions, including, but not limited to, balance inquiries, and/or fund transfers. For example, as seen in FIG. 2B (which illustrates the described interactions between a user's mobile device executing a mobile device application, an EGM associated with a SMIB, an electronic funds transfer service, an external funding service, a payment gateway, a banking network and a bank), certain embodiments of transferring funds from an external account maintained by an external funding source (i.e., a bank) to an EGM associated with a SMIB include various gaming establishment components and non-gaming establishment components operating together to transfer, subject to certain transfer fees, an amount of funds from an external account to a credit balance of the EGM.

In different embodiments, the accounts of the external funding sources include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts). It should be appreciated that different accounts of different external funding sources are associated with different amounts of times needed to complete a transfer of funds and also associated with different fee amounts charged to complete a transfer of funds. For example, transfers of funds from a credit card account are typically associated with higher fees (e.g., a 3% fee imposed on the amount transferred) and a quicker fund transfer completion time (e.g., funds are available within five minutes) than transfers of funds from a bank checking account which are associated with lower fees (e.g., a 1% fee imposed on the amount transferred) and a slower fund transfer completion time (e.g., funds are available within five days). In certain embodiments, the fee is a percentage of the amount of funds transferred from the external account which is paid at the time of the transfer from the external account. In certain embodiments, the fee is additionally or alternatively a static amount paid at the time of the transfer from the external account. It should be appreciated that while generally described as transferring funds from an external account to a gaming establishment device of an EGM, in different embodiments, funds accessed from an external account may be transferred to any suitable non-EGM gaming establishment device operable to receive funds, such as, but not limited to, a kiosk or a retail point-of-sale terminal associated with a gaming establishment.

In certain embodiments, the gaming establishment fund management system includes or is otherwise in communication with a refund system that operates to refund part or all of the fees imposed in association with one or more transfers of funds from an external account. In certain such embodiments, one or more servers of the refund system (i.e., a refund host) track and evaluate zero, one or more activities to determine whether or not part or all of one or more fees associated with zero, one or more external account transfers should be refunded. In certain other embodiments, one or more servers separate from the refund system track one or more activities and communicate data associated with any tracked activities to one or more servers of the refund system to evaluate and determine whether or not part or all of one or more fees associated with zero, one or more external account transfers should be refunded.

In certain embodiments, the gaming establishment fund management system includes or is otherwise in communication with one or more gaming establishment patron management systems, such as one or more player tracking systems, that maintain data associated with one or more users, monitor activities at various points of contact associated with the gaming establishment and provides rewards, such as redeemable player tracking points, to such users in association with the monitored activities. For example, as seen in FIG. 1, the gaming establishment fund management system that maintains the enterprise wallet 104 is in communication with a patron management system 124 which maintains one or more databases including information regarding gaming establishment patrons.

In certain embodiments, the system is in communication with a distinct and independently operating ticket voucher system. In certain embodiments, as seen in FIG. 1, the system includes a ticket voucher system 126. In these different embodiments, the ticket voucher system includes one or more servers which store, in one or more databases, ticket voucher identification information associated with each ticket voucher created by the ticket voucher system, such as identifying information, value information, and/or imposed fee information. In certain embodiments, each ticket voucher includes or is otherwise associated with different identifying information which is identifiable to a holder of the ticket voucher, such as a ticket voucher validation number, and an amount of funds associated with the ticket voucher. In different embodiments, the ticket voucher database and/or the ticket voucher includes or is otherwise associated with various fields of ticket voucher identifying information including, but not limited to: (i) a primary key (i.e., an index for a record in a table); (ii) a ticket voucher validation number (i.e., the validation number associated with the issued ticket); (iii) a ticket state (e.g., a state of a ticket as being in an issued state or a redeemed state); (iv) an issuance date/time (i.e., the date/time when the ticket voucher was issued); (v) a property address associated with the ticket voucher issuance; (vi) an amount of funds associated with the ticket voucher; (vii) any expiration date associated with the ticket voucher; (viii) a device identification associated with the issuance of the ticket voucher; (ix) an image of the ticket voucher (e.g., an image of a front of the ticket voucher and/or an image of a back of the ticket voucher); (x) any redemption date (i.e., the date the ticket voucher was redeemed at (if the ticket voucher is in the redeemed state)); (xi) redeemed at (i.e., the device where the ticket voucher was redeemed (if the ticket voucher is in the redeemed state)); (xii) a data signature (i.e., a signature of the data associated with the ticket voucher to prevent tampering by casino employees); (xiii) a machine identification (i.e., an asset or machine number of the device that printed the ticket voucher); (xiv) any fees imposed based on any external account transfers associated with the ticket voucher; and/or (xv) any refunds of any fees imposed based on any external account transfers associated with the ticket voucher.

In addition to maintaining information associated with each ticket voucher, in certain embodiments wherein the ticket voucher takes the form of a paper ticket voucher, the ticket voucher system includes one or more ticket voucher system components, such as a ticket voucher printer configured to print paper ticket vouchers and/or a ticket voucher acceptor configured to receive paper ticket vouchers. For example, a ticket voucher printer is associated with a gaming establishment device that prints ticket vouchers. In certain other embodiments wherein a ticket voucher takes the form of a virtual ticket voucher, the ticket voucher system includes one or more interfaces operable to communicate, to a mobile device, data associated with a virtual ticket voucher.

In certain embodiments, the gaming establishment fund management system includes or is otherwise in communication with one or more credit systems which each issue the user one or more lines of credit or markers. In certain embodiments, these lines of credit or markers are accessible to facilitate a transfer of funds from the line of credit issued by the credit system to, either directly or indirectly through a cashless wagering account, a credit balance of a gaming establishment device, such as an EGM and/or a gaming table. In this example, to facilitate a transfer of funds from the line of credit issued by the credit system to a credit balance of an EGM and/or a gaming table, the system utilizes a mobile device running a mobile device application that interfaces with one or more components of the credit system to enable a user, such as a player of the EGM or a player at the gaming table, access to the issued line of credit. In certain embodiments, these lines of credit or markers are additionally or alternatively accessible to facilitate a transfer of funds from the line of credit issued by the credit system to, either directly or indirectly through a cashless wagering account, a balance of a gaming establishment retail account to facilitate a gaming establishment retail transaction. In certain embodiments, the gaming establishment fund management system includes or is otherwise in communication with one or more credit reporting/credit risk systems which monitor and report on various accounts associated with the user. These credit reporting and risk systems monitor and report on a credit rating and status of one or more accounts maintained for the user at various funding sources, such as various financial institutions.

In certain embodiments, the gaming establishment fund management system includes or is otherwise in communication with one or more front money handling systems which each maintain an amount of front money provided by a user in a front money account. For example, the gaming establishment fund management system that maintains the enterprise wallet is in communication with a gaming establishment front money handling system to facilitate the access of an amount of funds via front money provided by the user. Such front money is provided by the user, such as via the user depositing cash, gaming table chips, a personal check, a bank draft, a money order or a wire transfer into a front money account associated with the user. The balance of the front money is drawn down from the front money account (in certain instances via the issuance of markers) and accessible by the front money handling system to (either directly or indirectly through a cashless wagering account) a credit balance of a gaming device, such as an EGM and/or a gaming table and/or to (either directly or indirectly through a gaming establishment retail account) a point-of-sale terminal (or an account associated with the point-of-sale terminal).

In certain embodiments, the system utilizes one mobile device application to interact with the different components of (or in communication with) the gaming establishment fund management system to, amongst other actions, access funds maintained in the different accounts associated with the user. For example, utilizing the same mobile application, a mobile device interacts with both the first cashless wagering system of the gaming establishment fund management system and the gaming establishment retail wallet system of the gaming establishment fund management system. In certain embodiments, the system utilizes multiple mobile device applications to interact with the different components of (or in communication with) the gaming establishment fund management system to, amongst other actions, access funds maintained in the different accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

In certain embodiments, to interact with one or more components of (or in communication with) the system, the system enables a user to pair or link their mobile device to a gaming establishment device, such as a gaming device (e.g., an EGM) or a non-gaming device (e.g., a point-of-sale terminal). In these embodiments, the pairing or linkage between the mobile device and the gaming establishment device occurs via one or more applications being run or executed on the mobile device. In certain such embodiments, the mobile device application prompts the user to cause the mobile device to engage the gaming establishment device or a component of the gaming establishment device (e.g., a SMIB) or other component of a gaming establishment management system supported by an EGM). After any required engagement, the mobile device application communicates, via a wireless communication protocol (including, but not limited to: Bluetooth™, Bluetooth™ Low Energy (“BLE”), one or more cellular communication standards (e.g., 3G, 4G, 5G, 6G, LTE), one or more Wi-Fi compatible standards, and one or more short range communication protocols (e.g., a near field communication (“NFC”) protocol), data associated with a requested action. Following the mobile device application communicating, via a wireless communication protocol, data associated with a requested action, the gaming establishment device (or a component of the gaming establishment device and/or the mobile device application) proceeds with operating with a component of (or in communication with) the gaming establishment fund management system to log the user into an account maintained by that component (if necessary) and request authorization of the requested action.

It should be appreciated that in different embodiments, in addition to or alternatively from utilizing a mobile device running a mobile device application to facilitate the completion of one or more actions and/or to interface with one or more components of any gaming establishment system and/or any non-gaming establishment system, the system utilizes a kiosk, a gaming device (e.g., an interface of an EGM or gaming table component), a service window displayed by a gaming device (e.g., a remote host controlled service window displayed by an EGM), a display device/input device associated with a seat-level gaming table component, a display device/input device associated with a table-level gaming table component, a display device/input device associated with a mobile gaming table component, a component of a gaming establishment patron management system, such as a player tracking unit, a retail point-of-sale terminal, and/or a gaming establishment interface, such as a casino desk, to facilitate the completion of one or more actions and/or to interface with one or more components of any gaming establishment system and/or any non-gaming establishment system. Additionally, while illustrated in FIG. 1 as using a mobile device running a mobile device application to enable a user access to one or more components of one or more gaming establishment systems and/or non-gaming establishment systems, in different embodiments, a physical instrument, such as a smart card or a user issued magnetic striped card may additionally or alternatively be utilized to enable a user such access to one or more components of one or more gaming establishment systems and/or non-gaming establishment systems.

It should be appreciated that any component or sub-system of the present disclosure can be in communication with any other component and any two or more of the systems, sub-systems and components of the present disclosure may be combined into a single system, sub-system or component. For example, while an external funding system and the gaming establishment fund management system are illustrated as separate components, the external funding system and the gaming establishment fund management system may be combined into a single component operable to accomplish the various tasks each of such separate components are described as accomplishing individually.

In certain embodiments, the system enables a transfer of funds between different external accounts and different gaming establishment components to enable different gaming activities and/or non-gaming activities. In these embodiments, the system employs a service for interfacing with the various components to facilitate balance inquiries and the transfer of funds. In certain embodiments, such a service collects data from various components and utilizes such collected data to provide a singular view of the balances (or a plurality of singular views of different groupings of balances) available. In certain embodiments, such a service additionally or alternatively provides facilities to enforce rules and/or limitations including, but are not limited to, jurisdictional controls, self-imposed limits, state governmental controls and federal governmental controls, wherein the system provides the logic to determine how, and how much, to transfer to satisfy a request for funds while staying within the confines of such rules. In certain embodiments, such a service additionally or alternatively tracks and coalesces transaction history of the interconnected components of the system. In these embodiments, all transactions within the system have a “master” transaction record that ties all of the various fund transfers to a single initiating funds transfer.

In various embodiments, following the transfer of funds from an external account to a gaming establishment device and the payment of a fee to facilitate such a transfer, the system monitors for various activities occurring at the gaming establishment device and/or remote from the gaming establishment device that may result in the return of part or all of the fees paid to facilitate the transfer. That is, the system tracks the occurrences of one or more events and determines, based on such tracked occurrences, whether a refund triggering event occurs. Responsive to the occurrence of a refund triggering event, the system determines an amount of the refund of the imposed fees to provide, a form of such a refund (e.g., providing the refund a cashable credits, non-cashable credits and/or promotional credits) and/or a funding avenue of such a refund (e.g., providing the refund as a credit to a gaming establishment account, a credit to an EGM credit balance or an issued ticket voucher).

In certain embodiments, such tracking of the occurrences of one or more events occurs based on the satisfaction of one or more conditions. In these embodiments, the system tracks certain events if certain criteria associated with the user and/or the system are otherwise met. In certain such embodiments, a condition that needs to be met in association with the tracking of the occurrences of one or more events is based on one or more metrics of a user. Such metrics include, but are not limited to, a status of the user (e.g., events are tracked for players with a player tracking account or players with a player tracking account of at least a designated status), a win rate of the user, a play rate of the user, a wagering history of the user and/or an average wager of the user. In these embodiments, if the user complies with one or more of these metrics, the system enables one or more events to be tracked to potentially result in a refund of part or all of the imposed fees. In certain additional or alternative embodiments, a condition that needs to be met in association with the tracking of the occurrences of one or more events is based on one or more properties of the gaming establishment device which the funds from the external account were transferred to (e.g., events are tracked at EGMs of certain themes or certain denominations but not tracked at EGMs of other themes or other denominations).

In certain embodiments, if one or more of any conditions are satisfied such that a refund of the imposed fees is potentially available, the system determines an event to track in association with a potential refund of part or all of a fee imposed in association with an external account fund transfer. In certain embodiments, the system determines to track a quantity of plays of a game. In certain embodiments, the system determines to track a quantity of winning plays of a game. In certain embodiments, the system determines to track a quantity of losing plays of a game. In certain embodiments, the system determines to track time playing a game. In certain embodiments, the system determines to track amounts wagered on one or more plays of a game. In certain such embodiments, the system separately tracks different wager amounts placed on the same game differently. In certain other embodiments, the system tracks a quantity of plays of a game (and/or an amount of time spent playing a game) independent of the wager amounts placed. In certain embodiments, the system determines to track an amount won playing a game. In certain embodiments, the system determines to track an amount lost playing one or more games.

In certain embodiments, the system tracks events associated with certain gaming establishment devices but not other gaming establishment devices. For example, if a refund is potentially available in association with a particular game cabinet (or type of game), the system tracks one or more events occurring in association with that particular game cabinet (or type of game). In different embodiments, the system tracks a quantity of plays of (and/or an amount of time playing) any suitable game including, but not limited to: any suitable spinning reels game, any suitable wheel game; any suitable card game such as blackjack, poker or baccarat; any suitable keno game; any suitable bingo game; any suitable offer and acceptance game; any suitable award ladder game; any suitable puzzle-type game; any suitable persistence game; any suitable selection game; any suitable cascading symbols game; any suitable ways to win game; any suitable scatter pay game; any suitable coin-pusher game; any suitable elimination game; any suitable stacked wilds game; any suitable trail game; any suitable bingo game; any suitable video scratch-off game; any suitable pick-until-complete game; any suitable shooting simulation game; any suitable racing game; any suitable promotional game; any suitable high-low game; any suitable lottery game; any suitable number selection game; any suitable dice game; any suitable skill game; any suitable partial skill game; any suitable auction game; any suitable reverse-auction game; and/or any suitable group game.

In certain embodiments, the system determines to track one or more events associated with one or more plays of a game. In these embodiments, the system tracks events that occur as part or otherwise in association with an initiated play of a game, such as in association with one or more symbols randomly generated during a play of a game. In different embodiments, the trackable events include, but are not limited to: placing a side-wager (regardless of the side-wager amount); wagering on a number of paylines; wagering on a designated payline; wagering on a number of ways to win; engaging an input device of the EGM to cause a generation of an outcome; an activation of a reel (or a designated reel): an activation of a plurality of reels; a generation of any outcome (or a designated outcome); a generation of any outcome (or a designated outcome) associated with an award; a generation of any outcome (or a designated outcome) associated with an award over a designated value; a generation of an outcome (or a designated outcome) on a designated payline; a generation of an outcome (or a designated outcome) in a scatter configuration; a generation of a winning way to win (or a designated winning way to win): a generation of a losing outcome, a generation of a designated symbol or symbol combination; a generation of a designated symbol or symbol combination on a designated payline; a generation of a designated symbol or symbol combination in a scatter configuration; a generation of a losing symbol combination, a triggering of a play of a secondary game; an activation of a secondary display; an activation of a community award generator; a generation of any outcome (or a designated outcome) in a secondary game; engaging an input device of the EGM to make a selection in a game; an activation of a feature (including, but not limited to, a feature which superimposed one or more symbols over the randomly generated symbols of the reels; a feature which replaces one or more symbols of the randomly generated symbols of the reels with a predetermined symbol pattern; a feature which replaces one or more symbols of the randomly generated symbols of the reels with a predetermined pattern of wild symbols; a modifier, such as a multiplier, feature; a book-end wild symbols feature; a stacked wild symbols feature; an expanding wild symbols feature; a nudging wild symbols feature; a feature modifying a quantity of wild symbols available to be generated; a retrigger symbol feature; an anti-terminator symbol feature; a locking reel feature; an expanding reel feature; a locking symbol position feature; a feature modifying a placed wager amount; a feature modifying a placed side wager amount; a feature modifying a number of wagered on paylines; a feature modifying a wager placed on one or more paylines (or on one or more designated paylines); a feature modifying a number of ways to win wagered on; a feature modifying a wager placed on one or more ways to win (or on one or more designated ways to win); a feature modifying a paytable utilized for a play of a game; a feature modifying an average expected payback percentage of a play of a game; a feature modifying an average expected payout of a play of a game; a feature modifying one or more awards available; a feature modifying a range of awards available; a feature modifying a type of awards available; a feature modifying one or more progressive awards; a feature modifying which progressive awards are available to be won; a feature modifying one or more modifiers, such as multipliers, available; a feature modifying an activation of a reel (or a designated reel); a feature modifying an activation of a plurality of reels; a feature modifying a generated outcome (or a designated generated outcome); a feature modifying a generated outcome (or a designated generated outcome) associated with an award over a designated value; a feature modifying a generated outcome (or a designated generated outcome) on a designated payline; a feature modifying a generated outcome (or a designated generated outcome) in a scatter configuration; a feature modifying a winning way to win (or a designated winning way to win); a feature modifying a designated symbol or symbol combination; a feature modifying a generation of a designated symbol or symbol combination on a designated payline; a feature modifying a generation of a designated symbol or symbol combination in a scatter configuration; a feature modifying a quantity of picks in a selection game; a feature modifying a quantity of offers in an offer and acceptance game; a feature modifying a quantity of moves in a trail game; a feature modifying an amount of free spins provided; a feature modifying a game terminating or ending condition; a feature modifying how one or more aspects of one or more games (e.g., colors, speeds, sound) are displayed to a user) in association with one or more plays of one or more games and/or any event associated with one or more plays of one or more games of the present disclosure. It should be appreciated that any suitable event occurring at or in association with the gaming establishment device which an amount of funds were directly or indirectly transferred to from an external account may be tracked by the system.

In certain embodiments, the system determines to track one or more events independent of any plays of any games. In these embodiments, the system tracks events that occur in association with a non-game related interaction. For example, the system operates with a gaming establishment patron management system to track meal purchases made at one or more restaurants associated with a gaming establishment. In different embodiments, such non-game related interactions include, but are not limited to, a user visiting one or more locations of (or independent from) a gaming establishment (e.g., tracking time spent in a casino), a user not visiting a gaming establishment (i.e., tracking time spent since a last casino visit), a user making one or more purchases at one or more retail locations of (or independent from) a gaming establishment, a user making one or more designated purchases at one or more retail locations of (or independent from) a gaming establishment, a user attending one or more events at (or independent from) a gaming establishment, a user utilizing one or more gaming establishment services, a user spending a quantity of player loyalty points (e.g., player tracking points), a user placing one or more sporting event wagers, playing an online game independent of a gaming establishment device, and/or a user attending a club and/or show associated with (or independent from) a gaming establishment. It should be appreciated that any suitable non-game play event occurring at the gaming establishment device which an amount of funds were directly or indirectly transferred to from an external account and/or any suitable event occurring independent of the gaming establishment device which an amount of funds were directly or indirectly transferred to from an external account may be tracked by the system.

In certain embodiments, the system randomly determines the event to track to potentially refund part or all of a fee imposed in association with an external account fund transfer. In certain embodiments, the system determines, based on which users are placing which wager amounts, the event to track to potentially refund part or all of a fee imposed in association with an external account fund transfer. In certain embodiments, the system determines, based on time/day, the event to track to potentially refund part or all of a fee imposed in association with an external account fund transfer. In certain embodiments, the system enables an operator of the system to determine the event to track to potentially refund part or all of a fee imposed in association with an external account fund transfer. In certain embodiments, the system enables a user, such as any user or a user having a player tracking status at or above a designated level, to determine the event to track to potentially refund part or all of a fee imposed in association with an external account fund transfer. In certain embodiments, the system enables a user to earn the ability, such as based on game play, to determine the event to track to potentially refund part or all of a fee imposed in association with an external account fund transfer. In certain embodiments, the system enables a user to purchase, with monetary funds and/or non-monetary funds (e.g., player tracking points and/or promotional credits), the ability to determine which event to track to potentially refund part or all of a fee imposed in association with an external account fund transfer.

It should be appreciated that in various embodiments, the events the system tracks to potentially refund part or all of a fee imposed in association with an external account fund transfer may be any suitable event which occurs in association with: (a) one or more plays of one or more primary games, (b) one or more plays of one or more secondary games, or (c) one or more occurrences which are independent of any primary or secondary games played. Accordingly, any action, any inaction, and/or any decision the user makes in association with their gaming experience (either at a gaming establishment device which received the funds from the external account or independent of the gaming establishment device which received the funds from the external account) may lead to a potential refund of part or all of a fee imposed in association with the external account fund transfer. Such a configuration thus provides that any suitable event, regardless of how often that event occurs, may be tracked and tied to triggering a potential refund of part or all of a fee imposed in association with an external account fund transfer.

In certain embodiments, the system randomly determines a quantity of events to track. In certain embodiments, the system determines, based on which users are placing which wager amounts, a quantity of events to track. In certain embodiments, the system determines, based on time/day, a quantity of events to track. In certain embodiments, the system enables an operator of the system to determine a quantity of events to track. In certain embodiments, the system enables a user, such as any user or a user having a player tracking status at or above a designated level, to determine a quantity of events to track. In certain embodiments, the system enables a user to earn the ability, such as based on game play, to determine a quantity of events to track. In certain embodiments, the system enables a user to purchase, with monetary funds and/or non-monetary funds (e.g., player tracking points and/or promotional credits), the ability to determine a quantity of events to track.

In addition to determining which event(s) to track, the system determines, for each event being tracked, a quantity of occurrences of that event that need to be tracked to trigger a refund of part or all of a fee imposed in association with an external account fund transfer. That is, the system determines the conditions that need to be satisfied in association with each of the tracked events to cause a refund of part or all of a fee imposed in association with an external account fund transfer to be unlocked or otherwise activated. In certain such embodiments, the quantity of occurrences of the event includes one occurrence such that if an event occurs, a refund of part or all of a fee imposed in association with an external account fund transfer occurs. In these embodiments, such a refund may randomly occur or occur responsive to one or more actions (or inactions) of a user. In certain other embodiments, the quantity of occurrences of the event includes a plurality of occurrences such that if an event occurs multiple times, a refund of part or all of a fee imposed in association with an external account fund transfer occurs.

In certain embodiments, the system randomly determines the quantity of occurrences of the tracked event that, when satisfied, triggers a refund of part or all of a fee imposed in association with an external account fund transfer. In certain embodiments, the system determines, based on which users are placing which wager amounts, the quantity of occurrences of the tracked event that, when satisfied, triggers a refund of part or all of a fee imposed in association with an external account fund transfer. In certain embodiments, the system determines, based on time/day, the quantity of occurrences of the tracked event that, when satisfied, triggers a refund of part or all of a fee imposed in association with an external account fund transfer. In certain embodiments, the system enables an operator of the system to determine the quantity of occurrences of the tracked event that, when satisfied, triggers a refund of part or all of a fee imposed in association with an external account fund transfer. In certain embodiments, the system enables a user, such as any user or a user having a player tracking status at or above a designated level, to determine the quantity of occurrences of the tracked event that, when satisfied, triggers a refund of part or all of a fee imposed in association with an external account fund transfer. In certain embodiments, the system enables a user to earn the ability, such as based on game play, to determine the quantity of occurrences of the tracked event that, when satisfied, triggers a refund of part or all of a fee imposed in association with an external account fund transfer. In certain embodiments, the system enables a user to purchase, with monetary funds and/or non-monetary funds (e.g., player tracking points and/or promotional credits), the ability to determine the quantity of occurrences of the tracked event that, when satisfied, triggers a refund of part or all of a fee imposed in association with an external account fund transfer.

In certain embodiments, the system employs a binary trigger in which if the quantity of occurrences of the tracked event are satisfied, the system triggers a refund of the fee imposed in association with an external account fund transfer. In certain embodiments, the system employs a scaled trigger in which different quantities of occurrences of the tracked event being satisfied result in different refund amounts. In these embodiments, the more tracked events that occur, the larger the refund will be. For example, after 100 games played, the system refunds 25% of the imposed fee and after 500 games played, the system refunds 50% of the imposed fee. In another example, the system refunds 10% of the amount lost (until the full fee is refunded) once a refund triggering event occurs.

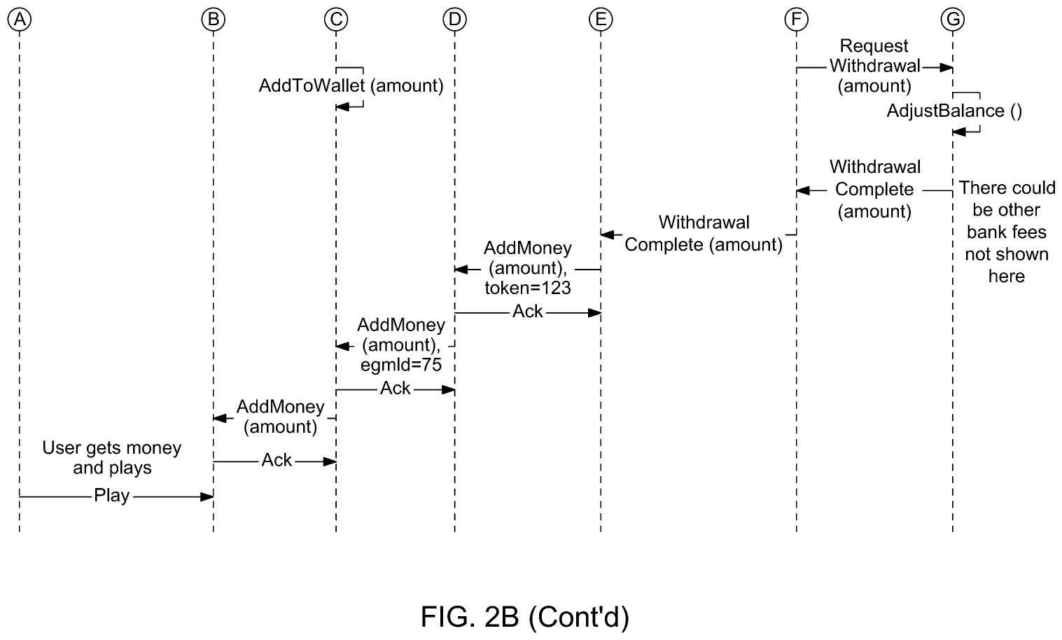

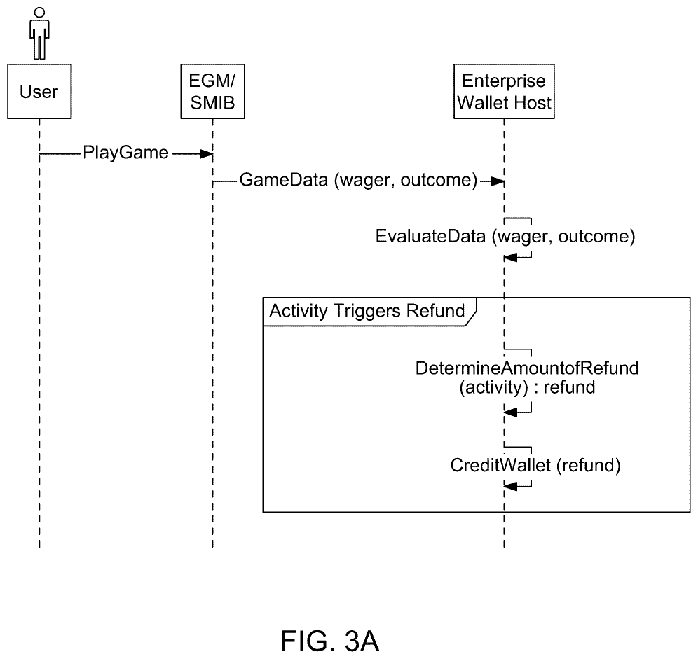

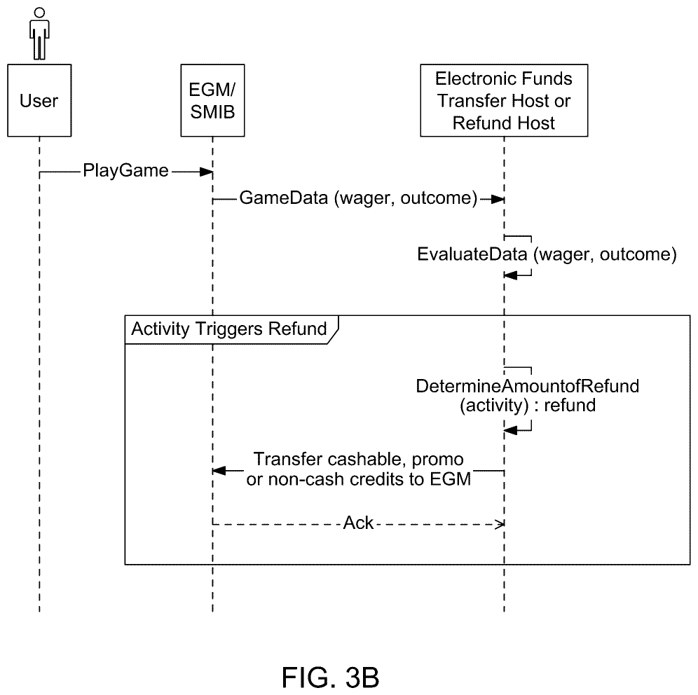

In certain embodiments, one or more gaming establishment fund management system components tasked with at least part of the transfer of the funds from the external account to the gaming establishment device track the occurrences of zero, one or more events and determines, based on such tracked events reaching one or more thresholds (and subject to any additional limits or restrictions), whether a complete or partial refund of fees imposed in association with the transfer of funds is warranted. In these embodiments, the gaming establishment device, such as an EGM, reports various data regarding events occurring at the gaming establishment device to the gaming establishment fund management system component which evaluates such data to determine if a refund triggering event occurs. If such a refund triggering event occurs (and no additional limits or restrictions are violated), the gaming establishment fund management system component determines an amount of the refund, such as a percentage of the fees imposed or a static amount. The gaming establishment management system component then operates to cause such a determined refund to be provided, such as via crediting a gaming establishment account associated with a user of the gaming establishment device. For example, as seen in FIG. 3A (which illustrates the described interactions between a user, an EGM and a SMIB associated with the EGM, and a component of a gaming establishment fund management system), certain embodiments include an EGM (or a SMIB associated with the EGM) communicating certain trackable data, such as game data, to the component of the gaming establishment fund management system (i.e., the enterprise wallet host) which tracks such data, determines whether a refund triggering event occurs based on the tracked data at least reaching a threshold and if so, determines an amount (and type) of a refund to credit a gaming establishment account maintained by the enterprise wallet host.

In certain embodiments, one or more refund system components (which are separate and distinct from any gaming establishment fund management system components tasked with at least part of the transfer of the funds from the external account to the gaming establishment device) track the occurrences of zero, one or more events and determines, based on such tracked events reaching one or more thresholds (and subject to any additional limits or restrictions), whether a complete or partial refund of fees imposed in association with the transfer of funds is warranted. In these embodiments, the gaming establishment device, such as an EGM, reports various data regarding events occurring at the gaming establishment device to the refund system component which evaluates such data to determine if a refund triggering event occurs. If such a refund triggering event occurs (and no additional limits or restrictions are violated), the refund system component determines an amount of the refund, such as a percentage of the fees imposed or a static amount. The refund system component then operates to cause such a determined refund to be provided, such as via crediting a credit balance of the gaming establishment device. For example, as seen in FIG. 3B (which illustrates the described interactions between a user, an EGM and a SMIB associated with the EGM, and a component of a refund system), certain embodiments include an EGM (or a SMIB associated with the EGM) communicating certain trackable data, such as game data, to the component of the refund system (i.e., the refund host) which tracks such data, determines whether a refund triggering event occurs based on the tracked data at least reaching a threshold and if so, determines an amount (and type) of a refund to credit a balance of the EGM. In another example, as alternatively seen in FIG. 3B, certain embodiments include an EGM (or a SMIB associated with the EGM) communicating certain trackable data, such as game data, to a component which executes the electronic funds transfer service (i.e., the electronic funds transfer host) which tracks such data, determines whether a refund triggering event occurs based on the tracked data at least reaching a threshold and if so, determines an amount (and type) of a refund to credit a balance of the EGM.

In certain embodiments, one or more gaming establishment fund management system components tasked with at least part of the transfer of the funds from the external account to the gaming establishment device track the occurrences of zero, one or more events and communicates data associated with such tracked events to one or more refund system components. In these embodiments, the refund system components determine, based on such tracked events reaching one or more thresholds (and subject to any additional limits or restrictions), whether a complete or partial refund of fees imposed in association with the transfer of funds is warranted. In certain other embodiments, one or more refund system components track the occurrences of zero, one or more events and communicates data associated with such tracked events to one or more gaming establishment fund management system components tasked with at least part of the transfer of the funds from the external account to the gaming establishment device. In these embodiments, the gaming establishment fund management system components determine, based on such tracked events reaching one or more thresholds (and subject to any additional limits or restrictions), whether a complete or partial refund of fees imposed in association with the transfer of funds is warranted.

In certain embodiments, in addition to tracking one or more events and utilizing such tracked events to determine if a complete or partial refund of any imposed fees is warranted, the system additionally applies one or more limits or restrictions on refunds that may be provided to one or more users. In certain such embodiments, in association with the movement of funds from an external account to a gaming establishment device (and in view of the potential subsequent movement of such funds elsewhere), the system imposes certain limits, such as responsible gaming limits and/or anti-money laundering limits, potentially not otherwise available. In these embodiments, the system determines if any external fund transfer transactions and/or fee refund transactions, individually or collectively, violate one or more imposed limits, and takes zero, one or more appropriate actions accordingly. In certain such embodiments which employ one or more limits on any fee refunds available, the system includes or is otherwise associated with a responsible gaming (and/or anti-money laundering) service which operates with other components of the system to monitor transactions occurring for potential violations of responsible gaming limits (and/or for activities potentially representative of money-laundering activities). In such embodiments, following one or more determinations made by the responsible gaming (and/or anti-money laundering) service based on data communicated from such other components (and/or data published to a service bus by one or more other components), the responsible gaming (and/or anti-money laundering) service operates to potentially cause one or more responsible gaming limits to be invoked (and/or cause one or more anti-money laundering actions to be undertaken) in association with the appropriate gaming establishment device.

In certain embodiments, since multiple funding pathways may be available to transfer funds from an external account and certain of such funding pathways include the transfer of funds from an external account that bypasses any gaming establishment account maintained by a gaming establishment fund management system (that otherwise includes capabilities to screen for violations of certain limits), the system operates to track funds transferred over multiple funding pathways and/or fees refunded from such fund transfers and, if such transactions violate one or more imposed limits, takes zero, one or more appropriate actions accordingly. For example, since the transfer of funds from a financial institution account (i.e., an external account) to an electronic gaming machine (i.e., a gaming establishment device) may occur in association with a cashless wagering account maintained by a cashless wagering system (that may impose funding limits) or independent of any cashless wagering accounts, the system monitors events occurring in association with at least these multiple funding pathways and enforces certain limits on a periodic basis to ensure that responsible gaming limits are met (and/or the system is not being abused to potentially launder money).

In certain embodiments, the system enables users to opt-out to receiving any refunds of fees imposed on transfers of funds from external accounts. For example, the system enables a user to opt-out of receiving any refunds of such fees by interfacing with an externally controlled interface (e.g., a remote host controlled service window) displayed by a gaming establishment device. In another example, the system enables a user to opt-out of receiving any refunds of such fees by interfacing with gaming establishment personnel and requesting that one or more accounts associated with the user be updated to reflect the user's preferences. In certain embodiments, the system determines if a user is currently associated with any responsible gaming exclusion lists and if so, the system opts the user out from receiving any refunds of fees imposed on transfers of funds from external accounts. In certain embodiments, the system determines if a user is currently associated with any responsible gaming limits, such as in association with a player tracking account, and if so, the system opts the user out from receiving any refunds of fees imposed on transfers of funds from external accounts.

In certain embodiments, rather than completely opting out of and not participating in receiving any refunds of fees imposed on transfers of funds from external accounts, the system limits the amount of the refunds available to a user. In one such embodiment, the system limits the amount of refund per period, such as a limit of $40 in refunds in a 24-hour period. In another such embodiment, the system limits the number of times a refund can be applied, such as three refunds per 24-hour period. In another embodiment, the system limits the refund amount based on the responsible gaming configuration. For example, if a user has opted into a responsible gaming exclusion list, while other users may receive an $8 refund against an $8 fee charged, the system limits the responsible gaming exclusion list user to only a $1 refund (when the same $8 fee is charged).

In certain embodiments, if one or more components individually or collectively determine that a complete or partial refund of imposed fees is warranted, such components, individually or collectively, provide the refund when earned. In these embodiments, the determination to provide a refund of part or all of the fees associated with a transfer of funds from an external account qualifies as an occurrence of a refund realization event which results in the refund being issued to the user, such as via crediting a gaming establishment account associated with the user or crediting a balance of a gaming establishment device being interfaced with by the user.

In certain embodiments, if one or more components individually or collectively determine that a complete or partial refund of imposed fees is warranted, such components, individually or collectively, cause the refund to be providable when earned. In these embodiments, the determination to provide a refund of part or all of the fees associated with a transfer of funds from an external account qualifies as an occurrence of a refund realization event such that upon one or more actions being undertaken, the system delivers the refund to the user.

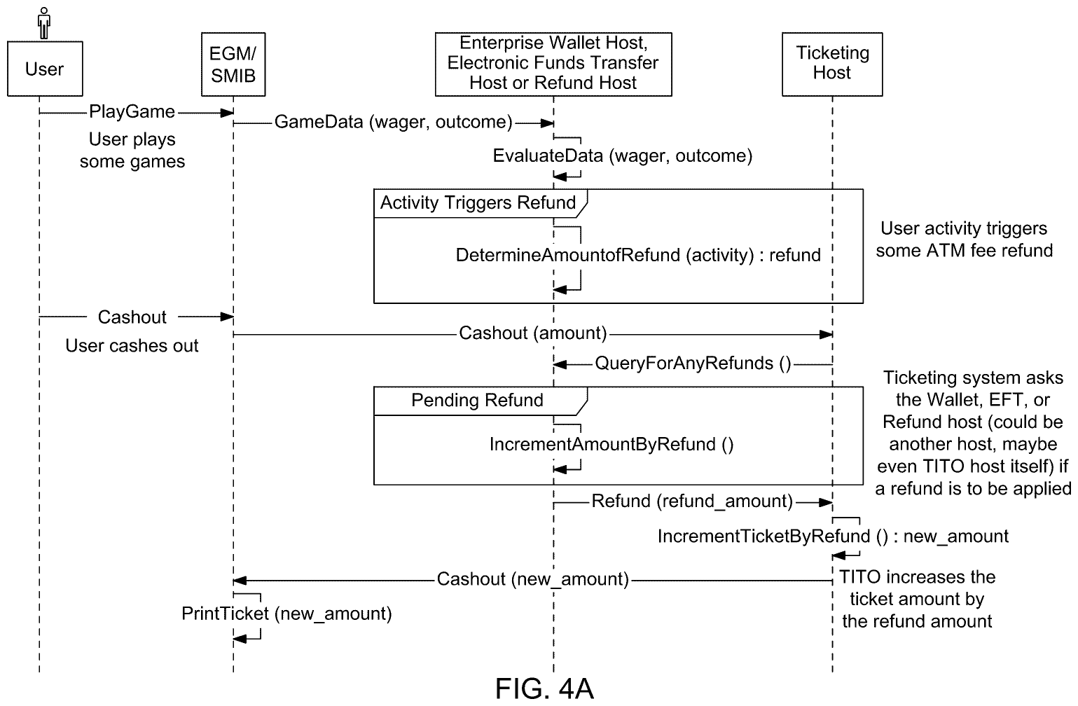

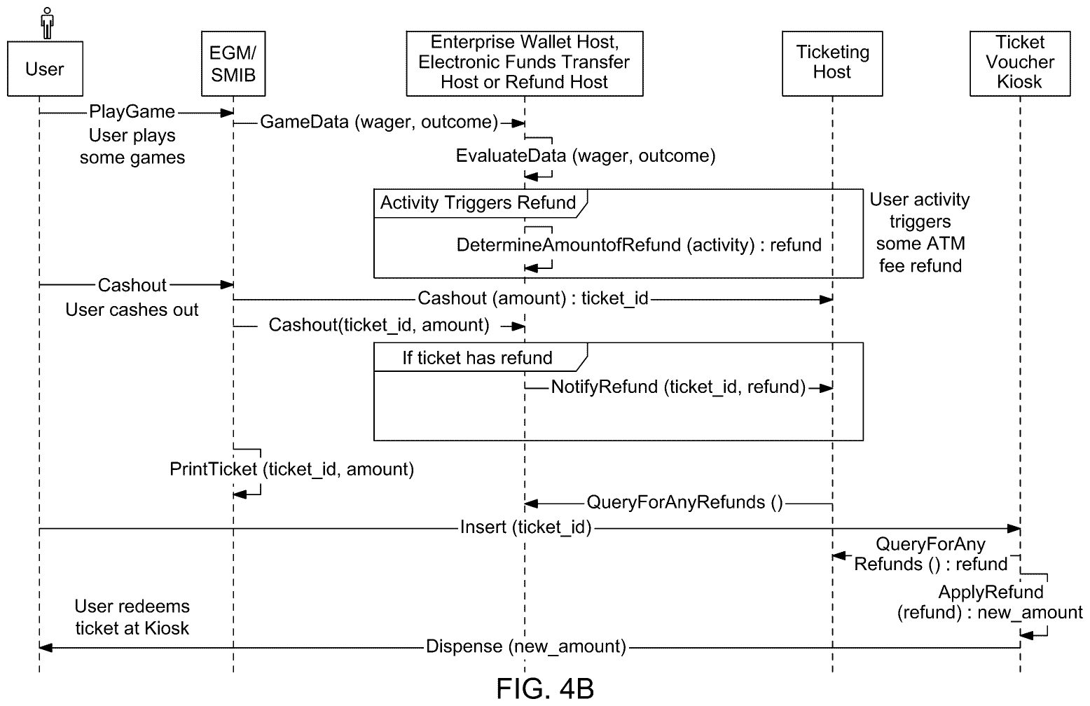

In certain embodiments, rather than issuing the refund to the user via crediting a gaming establishment account associated with the user or crediting a balance of a gaming establishment device being interfaced with by the user, the system employs a ticket voucher to deliver the refund to the user. In certain such embodiments, following a user requesting a cashout of a balance of a gaming establishment device to a ticket voucher (i.e., an action undertaken that qualifies as a refund realization event), a component of a ticket voucher system operates with one or more components tasked with determining if a complete or partial refund of imposed fees is warranted to determine whether or not to provide a fee refund in association with the issuance of a ticket voucher. In these embodiments, if a refund is owed to the user, the ticket voucher system associates the amount of the refund with an issued ticket voucher and updates one or more databases to reflect that the ticket voucher is additionally (or alternatively) associated with the amount of the refund. For example, as seen in FIG. 4A (which illustrates the described interactions between a user, an EGM and a SMIB associated with the EGM, a component of a refund system and a component of a ticket voucher system), certain embodiments include an EGM (or a SMIB associated with the EGM) communicating certain trackable data, such as game data, to the component of the refund system (i.e., the refund host) which tracks such data, determines whether a refund triggering event occurs based on the tracked data at least reaching a threshold and if so, determines an amount of a refund. In this example, the component of the refund system then interfaces with a component of the ticket voucher system (i.e., the ticketing host) to cause a ticket voucher associated with at least the amount of the refund to be issued in association with the received cashout request at the EGM. In another example, as alternatively seen in FIG. 4A, certain embodiments include an EGM (or a SMIB associated with the EGM) communicating certain trackable data, such as game data, to a component which maintains a gaming establishment account (i.e., an enterprise wallet host) which tracks such data, determines whether a refund triggering event occurs based on the tracked data at least reaching a threshold and if so, determines an amount of a refund. In this example, the component which maintains the gaming establishment account then interfaces with a component of the ticket voucher system (i.e., the ticketing host) to cause a ticket voucher associated with at least the amount of the refund to be issued in association with the received cashout request at the EGM. In another example, as further alternatively seen in FIG. 4A, certain embodiments include an EGM (or a SMIB associated with the EGM) communicating certain trackable data, such as game data, to a component which executes the electronic funds transfer service (i.e., the electronic funds transfer host) which tracks such data, determines whether a refund triggering event occurs based on the tracked data at least reaching a threshold and if so, determines an amount of a refund. In this example, the component which executes the electronic funds transfer service then interfaces with a component of the ticket voucher system (i.e., the ticketing host) to cause a ticket voucher associated with at least the amount of the refund to be issued in association with the received cashout request at the EGM.

In certain other embodiments in which the system employs a ticket voucher to deliver the refund to the user, the system enables a user to request any owed refund without having to request a cashout of a balance of a gaming establishment device to a ticket voucher. In these embodiment, following a user requesting a ticket voucher associated with a refund owed (i.e., an action undertaken that qualifies as a refund realization event), a component of a ticket voucher system operates with one or more components tasked with determining if a complete or partial refund of imposed fees is warranted to determine whether or not to provide a fee refund in association with an issuance of a ticket voucher. In these embodiments, if a refund is owed to the user, the ticket voucher system associates the amount of the refund with an issued ticket voucher and updates one or more databases to reflect that the ticket voucher is associated with the amount of the refund.

In certain embodiments, if a fee refund should be delivered to a user via a ticket voucher, the system employs a single ticket voucher that is associated with an amount of the balance of the gaming establishment device plus the amount of the refund. In other embodiments, if a fee refund should be delivered to a user via a ticket voucher, the system employs a separate ticket voucher that is associated with the amount of the refund (such that another ticket voucher is associated with an amount of the balance of the gaming establishment device).

In certain embodiments, following the issuance of a fee refund delivered via a ticket voucher, the system enables the user redeem the issued ticket voucher at a ticket voucher kiosk and/or by interfacing with gaming establishment personnel, such as at a casino cage. For example, as seen in FIG. 4B (which illustrates the described interactions between a user, an EGM and a SMIB associated with the EGM, a component of a refund system, a component of a ticket voucher system and a ticket voucher kiosk), certain embodiments include an EGM (or a SMIB associated with the EGM) communicating certain trackable data, such as game data, to the component of the refund system (i.e., the refund host) which tracks such data, determines whether a refund triggering event occurs based on the tracked data at least reaching a threshold and if so, determines an amount of a refund. In this example, the component of the refund system then interfaces with a component of the ticket voucher system (i.e., the ticketing host) to cause a ticket voucher associated with at least the amount of the refund to be issued in association with the received cashout request at the EGM. In this example, following the issuance of the ticket voucher, the system enables the ticket voucher to be redeemed at a ticket voucher kiosk for the amount of the refund. In certain embodiments, the issued ticket voucher is immediately redeemable for the refunded fees. In certain other embodiments, the issued ticket voucher is redeemable for the refunded fees after a period of time.

In certain embodiments, if one or more components individually or collectively determine that a complete or partial refund of imposed fees is warranted (i.e., a refund triggering activity event occurred), such components, individually or collectively, provide the refund at a later point in time following a subsequently occurring refund realization event. In one such embodiment, a refund realization event periodically occurs at a designated interval such that if a refund of imposed fees is owed, the system provides the refund at the next designated interval, such as an interval of time and/or games played. In another such embodiment, a refund realization event occurs responsive to a satisfaction of a refund realization condition. In certain such embodiments, a refund realization condition is satisfied based on one or more events (or the lack of one or more events) occurring in association with a user's current engagement with the gaming establishment device, such as, but not limited to, after a losing game outcome, a series or streak of losing game outcomes and/or upon a determination that a user is losing interest in engaging the gaming establishment device (as determined by analyzing rate of play, wagering patterns and/or how the user is otherwise interacting (or not) with the gaming establishment device).

In certain other embodiments, a refund realization condition is satisfied based on one or more events (or the lack of one or more events) occurring in association with a user's subsequent engagement with the gaming establishment device (or with another gaming establishment device). In these embodiments, the system tracks activities occurring in association with a current session at a gaming establishment device and responsive to the tracked activities warranting a refund of part or all of the fees imposed in association with a transfer of funds from an external account, the system accrues refund credits in association with a user, such as in association with an account (e.g., a cashless wagering account, a player tracking account or an accrued refund credits account) maintained for that player. Such refund credits are applicable (in certain instances automatically) to offset any applicable fees imposed when a user subsequently makes a transfer of funds from an external account to a gaming establishment device. Such a configuration aids certain users by enabling such users to continue to transfer funds into the gaming establishment from an external funding source due to not having to pay the full fee amount for their next transfer (and/or subsequent transfers). In certain embodiments, any accrued refund credits persist until used. In certain other embodiments, one more accrued refund credits expire after a period of time. For example, an amount of accrued refund credits expire two weeks after being earned. In this example, a gaming establishment marketing system contacts the user, such as via a message displayed at any suitable device, via an email, via an SMS or text message, and/or via a notification displayed by a mobile device application, before expiration to alert the user of any upcoming expiring accrued refund credits.

Accordingly, in view of certain external accounts being associated with fee amount charged to complete a transfer of funds to a gaming establishment device and in view of certain users forgoing the transfer of funds to such gaming establishment devices because of these imposed fees, responsive to a determination that one or more activities occurring at (or in association with the gaming establishment device) warrant a refund eligibility, the system provides part or all of such imposed fees to the user. Such a configuration thus minimizes or eliminates the impact of such fees and encourages the transfer of funds from such external accounts to one or more gaming establishment devices. As such, to mitigate the ramifications of certain fees imposed in association with one or more transfers of funds to a gaming establishment device, the system causes certain users whom satisfy certain eligibility conditions to recoup part or all of such fees (to minimize the known psychological impact that these fees have on certain users) and thus to realize the technical benefits of a cashless gaming establishment environment.

In certain embodiments, rather than transferring an amount of funds from an external account to a gaming establishment device or from an external account to a gaming establishment account associated with a user and then to a gaming establishment device (which each enable the tracking of activities associated with the gaming establishment device to determine any refund of part or all of any fee imposed from the external transfer), the system employs a ticket voucher as a vehicle which the amount of funds from the external account are initialed transferred to. In these embodiments, the system associates the ticket voucher with the fee imposed from the external transfer such that when the ticket voucher is subsequently redeemed, the system then tracks one or more activities which, as described above, may result in the refund of part or all of the imposed fee. That is, to enable a user to remain anonymous to at least the gaming establishment fund management system but still enable the user to avail themselves of the ability to recoup part or all of any fees imposed in association with a transfer of funds from an external account, the system utilizes one or more ticket vouchers to track which gaming establishment devices a user interacts with to then track any activities that cause part or all of such fees to be refunded.

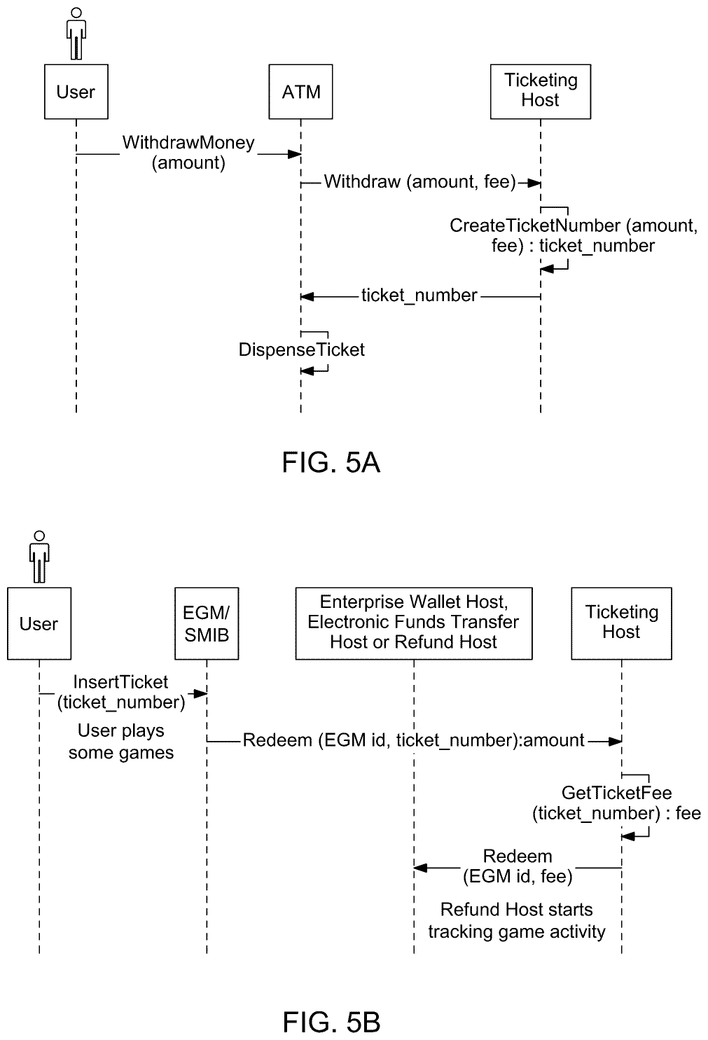

In certain embodiments, in association with a user obtaining one or more ticket vouchers, such as upon a user transferring an amount of funds from an external account to a balance of a ticket voucher kiosk (or an ATM) and the user cashing out the balance in exchange for a ticket voucher associated with an amount of funds of the cashed out balance, the system determines whether to associate any imposed fees from the transfer with that ticket voucher. In these embodiments, in creating a ticket voucher, the ticket voucher system operates with one or more other components to potentially associate any external account transfer fees with the ticket voucher to be dispensed. For example, as seen in FIG. 5A (which illustrates the described interactions between a user, an ATM and a component of a ticket voucher system), certain embodiments include the user withdrawing an amount of funds from an external account at an ATM and the ATM notifying a component of the ticket voucher system (i.e., the ticketing host) of any fees associated with the withdrawal such that the ticket voucher system associates such fees with the ticket voucher issued.

In certain embodiments, in addition to associating any imposed fees with a ticket voucher, the system utilizes such a ticket voucher to identify a gaming establishment device to track any activities at for a potential refund of such fees. In these embodiments, when the ticket voucher associated with any imposed fees is subsequently redeemed at a gaming establishment device, the system tracks, with or without identifying a user of the gaming establishment device, one or more activities which individually or collectively may result in part or all of these imposed fees being refunded. For example, as seen in FIG. 5B (which illustrates the described interactions between a user, an EGM and a SMIB associated with the EGM, a component of a refund system and a component of a ticket voucher system), certain embodiments include, following the redemption of a ticket voucher at an EGM, the EGM (or a SMIB associated with the EGM) operating with a component of the ticket voucher system (i.e., the ticketing host) to determine if the redeemed ticket voucher is associated with any imposed fees from an external account transfer. If so, the component of the ticket voucher system communicates data to a component of the refund system (i.e., the refund host) which then tracks certain trackable data, such as game data, in association with the redeemed ticket and proceeds with determining (not shown) whether a refund triggering event occurs based on the tracked data at least reaching a threshold and if so, an amount of a refund. In another example, as alternatively seen in FIG. 5B, certain embodiments include a component that maintains a gaming establishment account (i.e., an enterprise wallet host) operating with a component of the ticket voucher system to determine if the redeemed ticket voucher is associated with any imposed fees from an external account transfer. If so, the component of the ticket voucher system communicates data to the component that maintains the gaming establishment account which then tracks certain trackable data, such as game data, in association with the redeemed ticket to determine if any refund of such imposed fees is warranted. In another example, as alternatively seen in FIG. 5B, certain embodiments include a component that executes the electronic funds transfer service (i.e., the electronic funds transfer host) operating with a component of the ticket voucher system to determine if the redeemed ticket voucher is associated with any imposed fees from an external account transfer. If so, the component of the ticket voucher system communicates data to the component that executes the electronic funds transfer service which then tracks certain trackable data, such as game data, in association with the redeemed ticket to determine if any refund of such imposed fees is warranted.

It should be appreciated that the electronic fund transfers of the present disclosure may occur in addition to or as an alternative from cash-based fund transfers and/or ticket voucher-based fund transfers. It should be further appreciated that any functionality or process of the present disclosure may be implemented via one or more servers (associated with or independent of any component of any system disclosed herein), a mobile device application, one or more gaming establishment devices (e.g., a gaming device such as an EGM or a non-gaming device such as a point-of-sale terminal of a retailer located within or otherwise associated with a gaming establishment), and/or one or more components of a gaming establishment system (such as a component of a gaming establishment patron management system supported by or otherwise located inside a gaming establishment device and/or a non-gaming establishment device). Accordingly: (i) while certain functions, features or processes are described herein as being performed by one (or more) device (e.g., a server, a mobile device application, a gaming establishment device, a component of a gaming establishment system), such functions, features or processes may alternatively be performed, if applicable, by another such different devices.

In certain embodiments, the above-described embodiments of the present disclosure may be implemented in accordance with or in conjunction with zero, one or more components of any gaming establishment system (e.g., a gaming establishment patron management system, a gaming establishment fund management system, a ticket voucher system and/or a refund system), zero, one or more components of any non-gaming establishment system (e.g., a financial institution that maintains an external account) and/or zero, one or more gaming establishment devices. In these embodiments, such components of one or more gaming establishment systems, one or more non-gaming establishment systems and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the gaming establishment system, the component of the non-gaming establishment system, and/or the gaming establishment device; (3) accessing memory to configure or reconfigure parameters in the memory according to indicia read from the component of the gaming establishment system, the component of the non-gaming establishment system, and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the gaming establishment system, the component of the non-gaming establishment system, and/or the gaming establishment device, while in other embodiments, at least one component of the controller resides outside of the housing of the component of the gaming establishment system, the component of the non-gaming establishment system, and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the gaming establishment system, the component of the non-gaming establishment system, and/or the gaming establishment device of the present disclosure. In certain embodiments, the at least one memory device resides within the housing of the component of the gaming establishment system, the component of the non-gaming establishment system, and/or the gaming establishment device, while in other embodiments at least one component of the at least one memory device resides outside of the housing of the component of the gaming establishment system, the component of the non-gaming establishment system, and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the gaming establishment system, the component of the non-gaming establishment system, and/or the gaming establishment device; (2) associations between configuration indicia read from the component of the gaming establishment system, the component of the non-gaming establishment system, and/or the gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the gaming establishment system, the component of the non-gaming establishment system, and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the gaming establishment system, the component of the non-gaming establishment system, and/or the gaming establishment device to control the component of the gaming establishment system, the component of the non-gaming establishment system, and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) uses such a removable memory device in a component of the gaming establishment fund management system to implement at least part of the present disclosure. In other embodiments, part or all of the program code and/or the operating data is downloaded to the at least one memory device of the component of the gaming establishment system, the component of the non-gaming establishment system, and/or the gaming establishment device through any suitable data network described above (such as an Internet or intranet).

The at least one memory device also stores a plurality of device drivers. Examples of different types of device drivers include device drivers for the component of the gaming establishment system, the component of the non-gaming establishment system, and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the gaming establishment system, the component of the non-gaming establishment system, and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the gaming establishment system, the component of the non-gaming establishment system, and/or the gaming establishment device loads the new device driver from the at least one memory device to enable communication with the new device. For instance, one type of card reader in the component of the gaming establishment system, the component of the non-gaming establishment system, and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the gaming establishment system, the component of the non-gaming establishment system, and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the gaming establishment system, the component of the non-gaming establishment system, and/or the gaming establishment device. For example, the display devices serve as digital glass configured to display aspects of the gaming establishment device. In various embodiments, the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. For example, after the gaming establishment device receives an actuation, the gaming establishment device causes the payout device to provide a payment to the user. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. For example, the gaming establishment device provides dynamic sounds coupled with attractive multimedia images displayed on one or more of the display devices to provide an audio-visual representation or to otherwise display full-motion video with sound to attract users to the gaming establishment device. In certain embodiments, the gaming establishment device displays a sequence of audio and/or visual attraction messages during idle periods to attract potential users to the gaming establishment device. The videos may be customized to provide any appropriate information.

The at least one input device may include any suitable device that enables an input signal to be produced and received by the at least one processor of the component of the gaming establishment system, the component of the non-gaming establishment system, and/or the gaming establishment device. In one embodiment, the at least one input device includes a payment device configured to communicate with the at least one processor of the gaming establishment device to fund the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the gaming establishment device to be funded via an electronic funds transfer, such as a transfer of funds from a bank account. In another embodiment, the gaming establishment device includes a payment device configured to communicate with a mobile device of a user, such as a mobile phone, a radio frequency identification tag, or any other suitable wired or wireless device, to retrieve relevant information associated with that user to fund the gaming establishment device. When the gaming establishment device is funded, the at least one processor determines the amount of funds entered and displays the corresponding amount.

In various embodiments, the at least one input device includes a plurality of buttons that are programmable by the component of the gaming establishment system, the component of the non-gaming establishment system, and/or the gaming establishment device operator to, when actuated, cause the component of the gaming establishment system, the component of the non-gaming establishment system, and/or the gaming establishment device to perform particular functions. For instance, such buttons may be hard keys, programmable soft keys, or icons icon displayed on a display device of the gaming establishment device that are actuatable via a touch screen of the gaming establishment device or via use of a suitable input device of the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the gaming establishment system, the component of the non-gaming establishment system, and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the gaming establishment system, the component of the non-gaming establishment system, and/or the gaming establishment device, such as one or more rechargeable power sources (e.g., rechargeable batteries) located at the component of the gaming establishment system, the component of the non-gaming establishment system, and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the gaming establishment system, the component of the non-gaming establishment system, and/or the gaming establishment device; detecting the presence and/or identity of various persons (e.g., users, casino employees, etc.), devices (e.g., user input devices), and/or systems within a predetermined proximity to the component of the gaming establishment system, the component of the non-gaming establishment system, and/or the gaming establishment device.

The at least one data preservation component is configured to detect or sense one or more events and/or conditions that, for example, may result in damage to the component of the gaming establishment system, the component of the non-gaming establishment system, and/or the gaming establishment device and/or that may result in loss of information associated with the component of the gaming establishment system, the component of the non-gaming establishment system, and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the component of the gaming establishment system, the component of the non-gaming establishment system, and/or the gaming establishment device to operate in a mobile environment.

The at least one geolocation module is configured to acquire geolocation information from one or more remote sources and use the acquired geolocation information to determine information relating to a relative and/or absolute position of the component of the gaming establishment system, the component of the non-gaming establishment system, and/or the gaming establishment device. For example, in one implementation, the at least one geolocation module is configured to receive GPS signal information for use in determining the position or location of the gaming establishment device. In another implementation, the at least one geolocation module is configured to receive multiple wireless signals from multiple remote devices and use the signal information to compute position/location information relating to the position or location of the gaming establishment device.

The at least one user identification module is configured to determine the identity of the current user or current owner of the component of the gaming establishment system, the component of the non-gaming establishment system, and/or the gaming establishment device. For example, in one embodiment, the current user is required to perform a login process at the component of the gaming establishment system, the component of the non-gaming establishment system, and/or the gaming establishment device in order to access one or more features. Alternatively, the component of the gaming establishment system, the component of the non-gaming establishment system, and/or the gaming establishment device is configured to automatically determine the identity of the current user based on one or more external signals, such as an RFID tag or badge worn by the current user and that provides a wireless signal to the component of the gaming establishment system, the component of the non-gaming establishment system, and/or the gaming establishment device that is used to determine the identity of the current user. In at least one embodiment, various security features are incorporated into the component of the gaming establishment system, the component of the non-gaming establishment system, and/or the gaming establishment device to prevent unauthorized users from accessing confidential or sensitive information.

The at least one information filtering module is configured to perform filtering (e.g., based on specified criteria) of selected information to be displayed at one or more displays of the component of the gaming establishment system, the component of the non-gaming establishment system, and/or the gaming establishment device.

In various embodiments, the component of the gaming establishment system, the component of the non-gaming establishment system, and/or the gaming establishment device includes a plurality of communication ports configured to enable the at least one processor of the component of the gaming establishment system, the component of the non-gaming establishment system, and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the gaming establishment system, the component of the non-gaming establishment system, and/or the gaming establishment device has a support structure, housing, or cabinet that provides support for a plurality of the input devices and the output devices of the component of the gaming establishment system, the component of the non-gaming establishment system, and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor following a transfer of an amount of funds from a financial institution account maintained in association with a financial institution to a gaming establishment device and following a fee amount being assessed in association with the transfer of the amount of funds from the financial institution account to the gaming establishment device, cause the processor to:
track a quantity of occurrences of an activity associated with the gaming establishment device, and
responsive to the tracked quantity of occurrences of the activity at least reaching a threshold quantity of occurrences:
determine a refund amount of the fee amount assessed, and
communicate data associated with the determined refund amount of the fee to a component of a ticket voucher system, wherein responsive to an occurrence of a refund realization event, the component of the ticket voucher system causes a ticket voucher associated with at least the determined refund amount of the fee to be issued.

2. The system of claim 1, wherein the gaming establishment device comprise an electronic gaming machine.

3. The system of claim 2, wherein the refund realization event comprises a cashout input received by the electronic gaming machine.

4. The system of claim 3, wherein the issued ticket voucher is associated with the determined refund amount of the fee and a credit balance of the electronic gaming machine.

5. The system of claim 2, wherein the activity comprises at least one of an amount of games played, an amount wagered, an amount won, an amount lost, a game outcome obtained, and an amount of time spent playing a game.

6. The system of claim 1, wherein the refund realization event comprises a ticket voucher request received by the gaming establishment device and the issued ticket voucher is associated with the determined refund amount of the fee.

7. The system of claim 1, wherein the determined refund amount comprises a portion of the fee amount assessed.

8. The system of claim 1, wherein the transfer of the amount of funds from the financial institution account to the gaming establishment device comprises the amount of funds being transferred from the financial institution account to a gaming establishment account and at least a portion of the amount of funds being transferred from the gaming establishment account to the gaming establishment device.

9. The system of claim 1, wherein the transfer of the amount of funds from the financial institution account to the gaming establishment device occurs, independent of any gaming establishment account, in association with an electronic funds transfer.

10. A system comprising:
a processor; and
a memory device that stores a plurality of instructions that, when executed by the processor following a transfer of an amount of funds from a financial institution account maintained in association with a financial institution to an electronic gaming machine and following a fee amount being assessed in association with the transfer of the amount of funds from the financial institution account to the electronic gaming machine, cause the processor to:
responsive to a refund triggering activity event occurring in association with the electronic gaming machine, determine a refund amount of the fee amount assessed, and
responsive to a refund realization event subsequently occurring in association with the electronic gaming machine, cause at least the determined refund amount to be made available in association with a ticket voucher issued by a component of a ticket voucher system.

11. The system of claim 10, wherein the refund realization event comprises a cashout input received by the electronic gaming machine.

12. A method of operating a system, the method comprising:
following a transfer of an amount of funds from a financial institution account maintained in association with a financial institution to a gaming establishment device and following a fee amount being assessed in association with the transfer of the amount of funds from the financial institution account to the gaming establishment device:
tracking, by a processor, a quantity of occurrences of an activity associated with the gaming establishment device, and
responsive to the tracked quantity of occurrences of the activity at least reaching a threshold quantity of occurrences:
determining, by the processor, a refund amount of the fee amount assessed, and
communicating data associated with the determined refund amount of the fee to a component of a ticket voucher system, wherein responsive to an occurrence of a refund realization event, the component of the ticket voucher system causes a ticket voucher associated with at least the determined refund amount of the fee to be issued.

13. The method of claim 12, wherein the gaming establishment device comprise an electronic gaming machine.

14. The method of claim 13, wherein the refund realization event comprises a cashout input received by the electronic gaming machine.

15. The method of claim 14, wherein the issued ticket voucher is associated with the determined refund amount of the fee and a credit balance of the electronic gaming machine.

16. The method of claim 13, wherein the activity comprises at least one of an amount of games played, an amount wagered, an amount won, an amount lost, a game outcome obtained, and an amount of time spent playing a game.

17. The method of claim 12, wherein the refund realization event comprises a ticket voucher request received by the gaming establishment device and the issued ticket voucher is associated with the determined refund amount of the fee.

18. The method of claim 12, wherein the determined refund amount comprises a portion of the fee amount assessed.

19. The method of claim 12, wherein the transfer of the amount of funds from the financial institution account to the gaming establishment device comprises the amount of funds being transferred from the financial institution account to a gaming establishment account and at least a portion of the amount of funds being transferred from the gaming establishment account to the gaming establishment device.

20. The method of claim 12, wherein the transfer of the amount of funds from the financial institution account to the gaming establishment device occurs, independent of any gaming establishment account, in association with an electronic funds transfer.
